(19) United States
(12) Patent Application Publication
(10) Pub. No.: US 2018/0234407 A1
(43) Pub. Date: Aug. 16, 2018

(54) METHOD FOR SECURELY EXCHANGING LINK DISCOVERY INFORMATION

(71) Applicant: QUANTA COMPUTER INC., Taoyuan City (TW)

(72) Inventors: Cheng-Hsun LI, Taoyuan City (TW); Ching-Chih SHIH, Taoyuan City (TW)

(21) Appl. No.: 15/656,590

(22) Filed: Jul. 21, 2017

Related U.S. Application Data
(60) Provisional application No. 62/458,766, filed on Feb. 14, 2017.

(51) Int. Cl. H04L 29/06

(52) U.S. Cl. CPC H04L 63/083; H04L 63/20; H04L 63/062; H04L 63/123

(57) ABSTRACT

A network system is provided to coordinate nodes in a network topology to exchange neighbor information. The network system includes a plurality of processing nodes, where each processing node includes a processing node manager configured to receive a key via a secured connection, wherein the key comprises an instruction to forward advertised discovery packets to each of the plurality of processing nodes; send advertised discovery packets advertising network port information to each of the other plurality of processing nodes; and receive and examine advertised discovery packets from each of the other plurality of processing nodes, the advertised discovery packets comprising an authentication code, wherein examining the advertised discovery packets comprises verifying the authentication code is compliant with the received key.

### CROSS-REFERENCE TO RELATED APPLICATIONS

This application claims priority to and the benefit of U.S. Provisional Application No. 62/458,766, filed Feb. 14, 2017, the contents of which are herein incorporated by reference in their entirety.

### FIELD OF THE INVENTION

The present invention relates generally to the field of data security and more particularly to providing data security to network elements, specifically co-ordinate nodes are provided in a network topology to exchange neighbor information and prevent spoofing packets from disturbing the network topology generation.

### BACKGROUND

In a deployed network topology, such as in data center, each node may want to discover its neighbor's information. Generally, as more information is exchanged more applications can be developed based on the exchanged information. Well-known protocols which are designed for such purpose include, for example, Link Layer Discovery Protocol (LLDP) and Cisco Discovery Protocol (CDP). LLDP is a well-known neighbor discovery protocol, which allows Ethernet network devices to advertise topology information such as device configuration and identification details to neighboring devices. For example, an Ethernet blade switch can advertise the presence of its ports, major capabilities, and a current status to other LLDP stations in the same LAN. LLDP transmissions occur on ports at regular intervals or whenever there is a relevant change to their status. The switch can also receive LLDP information advertised from adjacent LLDP-capable network devices. The information is exchanged via a plurality of type-length-values (TLVs) provided in an LLDP packet during transmission. Similar to the LLDP, the CiscoWork system employs the CDP to automatically discover network devices. CDP is a media-independent device discovery protocol which can be used by an operator to view information about other network devices directly attached to a particular network device.

Although offered as an example, these protocols are multicast to a group of supported network nodes. Many applications rely on these discovery protocols to develop their own applications. An issue arises when multicasting these kinds of packets. Due to lack of security in authenticating the neighbor nodes, anyone can deceive the receiver node by sending the same kind of packet content and format to disturb receivers, so that the developed applications can no longer function normally. This may include for example, when a customer's operating system is hacked, or where malicious users intentionally want to spoof the network infrastructure. There exists a need for the network nodes to verify and identify which packet is valid and which is invalid.

### SUMMARY

Embodiments of the invention concern an apparatus, a network system and a method for providing data security to network elements. A network system according to the various embodiments can include a plurality of processing nodes. In some exemplary embodiments, the network system can include an authority node. Each processing node can include a processing node manager. Furthermore, one of the processing nodes in the plurality of processing nodes can be designated as a control node. In some embodiments, a processing node in the plurality of processing nodes is selected to receive a key via a secured connection. The key includes an instruction to forward advertised discovery packets to each of the processing nodes. In some embodiments of the disclosure, the selected processing node receives the key from the control node. In alternative embodiments, the selected processing node can receive the key from an authority node. In some embodiments, the selected processing node is configured to send the advertised discovery packets advertising network port information to each of the processing nodes. In response, the selected processing node can be configured to receive advertised discovery packets from the plurality of nodes. In some embodiments, the advertised discovery packets can include an authentication code. The selected processing node can be configured to examine the received advertised discovery packets to verify the authentication code received is in compliance with the received key.

In some embodiments, the selected processing node can be configured to examine the received advertised discovery packets to verify if the authentication code received is in compliance with the received key by verifying the same key is received. In an alternative embodiment, a ‘message authentication code(MAC)’ technique can be implemented to verify that the authentication code received is in compliance with the received key. Alternatively, in some embodiments of the disclosure additional encrypt/decrypt keys to encrypt message & MAC can be employed to verify if the authentication code received is in compliance with the received key. In some exemplary embodiments, encryption and decryption can use well-known methods, such as for example, RSA, Tripple DES, AES, etc.

In some embodiments, the advertised discovery packets include the key and application-specific information maintained in the processing node. In some embodiments, the control node can be configured to select at least one processing node from the plurality of processing nodes. In some embodiments, the control node is configured to generate and distribute a key to the selected processing node, where the key includes an instruction to the selected processing node to forward advertised discovery packets to each of the non-selected processing nodes. Alternatively, an authority node can be configured to select at least one processing node from the plurality of processing nodes. Moreover, in some embodiments, the authority node is configured to generate and distribute a key to the selected processing node, where the key includes an instruction to the selected processing node to forward advertised discovery packets to each of the non-selected processing nodes. In some embodiments, the control node is selected from the plurality of processing nodes by an authority node. Wherein, a control node is assigned by an authority node so that all nodes are coordinated by this control node (pod-manager). In some embodiments, the control nodes are determined by locality.

### BRIEF DESCRIPTION OF THE DRAWINGS

FIG. 1 is a block diagram of a distributed network system in accordance with embodiments of the disclosure as discussed herein;

FIG. 2 is a block diagram of the distributed network system 100 of FIG. 1 in which the components of FIG. 1 are illustrated in more detail;

FIG. 3 is a block diagram of the distributed network system 300 exemplifying the processing nodes 110n in accordance with embodiments of the disclosure;

FIG. 4 is a flow diagram exemplifying the process of the processing node for providing data security to network elements in accordance to an embodiment of the disclosure;

FIG. 5 is a flow diagram exemplifying the process of the authority node for providing data security to network elements in accordance to an embodiment of the disclosure; and

FIG. 6 illustrates a block diagram of an example computer system for implementing the various embodiments of the invention.

FIG. 7 illustrates an alternative embodiment in which a message authentication code technique is implemented to verify that the authentication code received is in compliance with the received key.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

In order to resolve the issue of the need for the network nodes to verify and identify which packet is valid and which is invalid, preferred embodiments of the present invention provide co-ordinate nodes in a network topology to exchange neighbor information and prevent spoofing packets from disturbing the network topology generation.

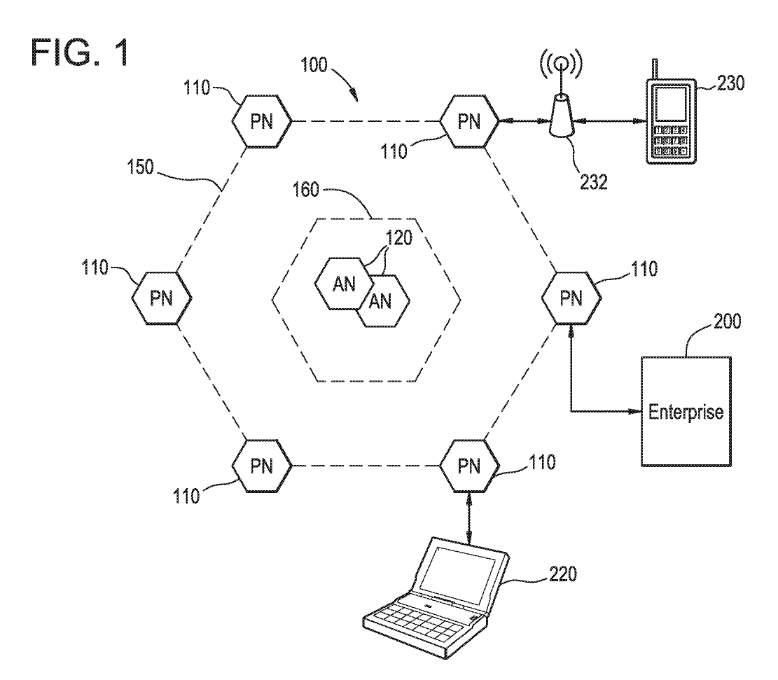

FIG. 1 is a block diagram of a distributed network system 100. The system 100 can, for example, be implemented as an overlay network in a wide area network (WAN), such as the Internet. The distributed network system 100 includes content processing nodes 110 that provide data security to network elements. Specifically, the content processing nodes are provided in a network topology to exchange neighbor information and prevent spoofing packets from disturbing the network topology generation, for e.g., malware, spyware, and other undesirable content sent from or requested by an external system. Example external systems can include an enterprise 200, a computer device 220, and a mobile device 230, or other network and computing systems.

Each processing node 110 can be implemented by a plurality of computer and communication devices, e.g., server computers, gateways, switches, etc. In some implementations, the processing nodes 110 can serve as an access layer 150. The access layer 150 can, for example, provide external system access to the distributed network system 100. In some implementations, each processing node 110 can include Internet gateways and a plurality of server computers.

A mobile device 230 may be configured to communicate with a nearby processing node 110 through any available wireless access device, such as an access point, or a cellular gateway 232. A single computer device 220, such as a consumer's personal computer, may have its browser and e-mail program configured to access the nearest processing node 110, which, in turn, serves as a proxy for the computer device 220. Alternatively, an Internet provider may have all of its customer traffic processed through processing nodes 110.

In some implementations, the processing nodes 110 can communicate with one or more authority nodes 120. The authority nodes 120 can store policy data for each processing nodes 110 and can distribute the policy data to each processing node 110. The policy data can, for example, define security policies for a protected system, e.g., security policies for the enterprise 200. Example policy data can define access privileges for users, web sites and/or content that is disallowed, restricted domains, etc. Furthermore, the policy data can include short time authorization keys distributed to each processing node 110 to verify and authenticate neighboring processing nodes 110. The authority nodes 120 can distribute the policy data to the processing nodes 110. In some implementations, each processing node 110 can function as a control node. That is, each processing node can be selected by a user at the external devices, or at an authority node 120, to be designated as a control node to forward policy data to the processing nodes 110. In some embodiments, the control nodes are determined by locality.

In some implementations, each authority node 120 can be implemented by a plurality of computer and communication devices, e.g., server computers, gateways, switches, etc. In some implementations, the authority nodes 120 can serve as an application layer 160. The application layer 160 can, for example, manage and provide policy data for the processing nodes 110. Other application layer functions can also be provided in the application layer, such as providing and defining security policies, e.g., generating and distributing a short time key to a processing node. In alternative embodiments, the access layer 150 can, for example, manage and provide policy data for the processing nodes 110. Other application layer functions can also be provided in the access layer 150, such as providing and defining security policies, e.g., generating and distributing a short time key to a processing node.

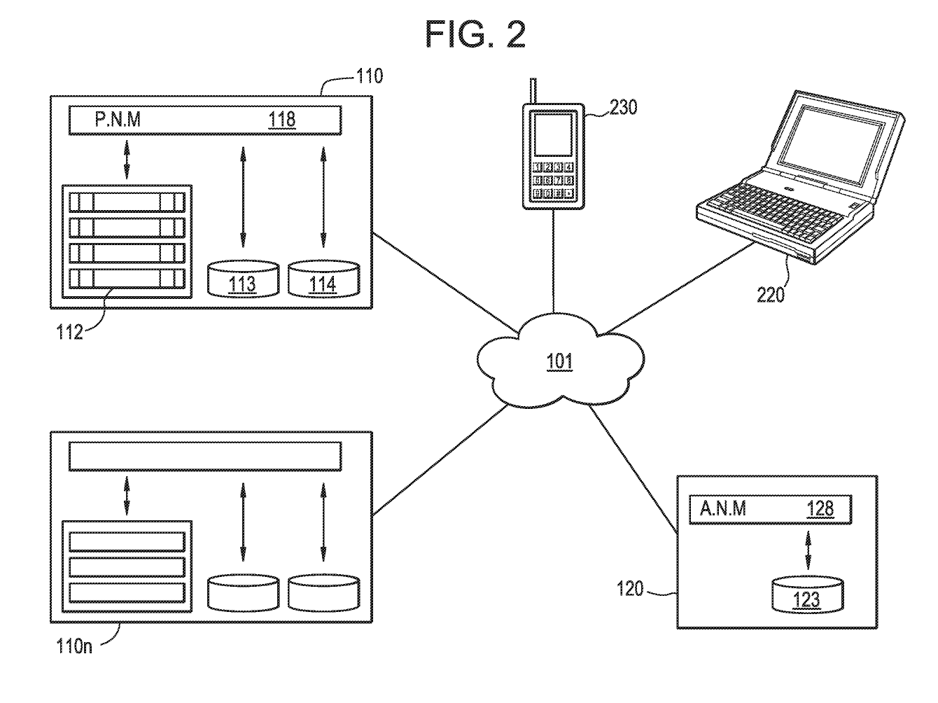

FIG. 2 is a block diagram of the distributed network system 100 of FIG. 1 in which the components of FIG. 1 are illustrated in more detail. The distributed network system includes a component processing node 110, processing nodes 110n, an authority node 120, a computer device 220, a mobile device 230, connected via an overlay network in a wide area network (WAN), such as the Internet 101. Although only one representative authority node 120 is illustrated, there can be many of each of the component nodes 110 and 120 present in the distributed network system 100. Furthermore, in an alternative embodiment, a processing node 110, operating as a control node can be presented performing the tasks of the authority node 120.

A processing node 110 can include a processing node manager 118, a policy data database 113, a detection process filter 112, and a network port information database 114. In some embodiments, the processing node manager 118 can manage each content item in accordance within the policy data database 113, a detection process filter 112, and a network port information database 114, such that security policies for a plurality of processing nodes 110n in data communication with the processing node 110 are implemented. In some embodiments, the processing node manager 118 can send policy data to the authority node 120. It should be understood that a control node can be configured identical to the processing node 110.

An authority node 120 can include an authority node manager 128, a master security policy data database 123 for each of the processing nodes 110. An authority node manager 128 can be used to manage the master security policy data 123, e.g., receive input from each of the processing nodes 110n defining different security policies, and distribute the security policy to each of the processing nodes 110. The processing nodes 110 then store a local copy of the security policy.

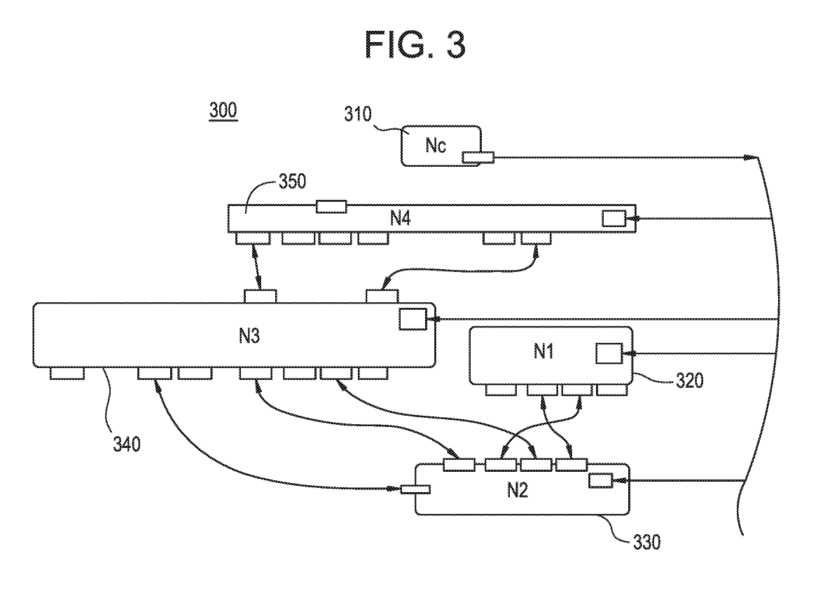

In some embodiments, the authority node manager 128 can select at least one processing node 110 from the plurality of processing nodes 110n. Furthermore, the authority node manager 128 can be configured to generate and distribute a security policy to a selected processing node 110. In some embodiments, the security policy can include a short time key that can include an instruction to direct the selected processing node 110 to forward advertised discovery packets to each of the remaining processing nodes 110n. This is discussed in depth with respect to FIG. 3.

The processing node manager 118 is configured to receive the short time key from the authority node manager 128 of the authority node 120. Because the amount of data being processed by the processing nodes 110 can be substantial, the detection processing filter 112 can be used to process requests to determine whether the requesting network device is valid or invalid. Where the detection processing filter 112 determines that short time key is authenticated and the requesting network device is valid, the short time key can include an instruction to direct the processing node 110 to forward advertised discovery packets to each of the remaining processing nodes.

In some embodiments, the processing node manager 118 is configured to advertise all network port information and the application-specific information stored within the network port information database 114 to the remaining processing nodes 110n. In some embodiments, the advertising of the network port information of the selected processing node can be arranged in a discovery packet sent to the other processing nodes 110n. Specifically, in some embodiments the discovery packets can include the short time key received from the authority node manager 128 of the authority node 120 and application-specific information maintained in the processing node 110.

The processing node manager 118 of selected processing node 110 can also receive and examine advertised packets from the other processing nodes 110n. In some embodiments, the advertised packets from the remaining processing nodes 110n can include an authentication code. Where the detection processing filter 112 determines the authentication code is in compliance with the short time key from the authority node 120, the processing node 110 can connect to the remaining processing nodes 110n.

FIG. 3 is a block diagram of the distributed network system 300 exemplifying the processing nodes 110n in accordance with embodiments of the disclosure. The distributed network system 300 can include authority node 310, processing node 320, processing node 330, processing node 340, and processing node 350. The authority node 310 selects which processing node will exchange information. Based on the selected processing node, the authority node 310 can generate a variable length passcode, denoted H_{AUTH}. Based on the variable length passcode, H_{AUTH}, the authority node 310 can start exchanging information over secure connections. The variable length passcode, H_{AUTH}, includes a secure passcode and a flag to signal the recipient processing node to start advertising and learning the neighboring node's information.

The processing node 320, processing node 330, processing node 340, and processing node 350 start advertising to each other discover packets. The discover packets contain network ports information of the processing node that sent the discover packets and the variable length passcode, H_{AUTH}, received from the authority node 310. For example, where the authority node 310 selects the processing node 320, the authority node instructs the processing node to advertise its network ports information and the variable length passcode, H_{AUTH}, received from the authority node 310 to the processing node 330, processing node 340, and processing node 350. The exchange in ports information can include, for example, the processing node's port's mac address.

Recipient of the variable length passcode, H_{AUTH}, enables the processing node to authenticate the request coming from the requesting processing node. For example, the processing node 350 can verify the request coming from the processing node 320. Each selected processing node can start to receive advertised packets from other processing nodes.

In some embodiments, the processing node 350 examines each packet which complies to the used discovery protocol. For example, where the receiving processing node determines that the advertised packet contains a variable length passcode, H_{AUTH} that is inconsistent with the variable length passcode, H_{AUTH} it received from the authority node 310, it will consider this an invalid packet. Upon this determination, the processing node will discard the packet. In this way, co-ordinate nodes are provided in a network topology to exchange neighbor information and prevent spoofing packets from disturbing the network topology generation.

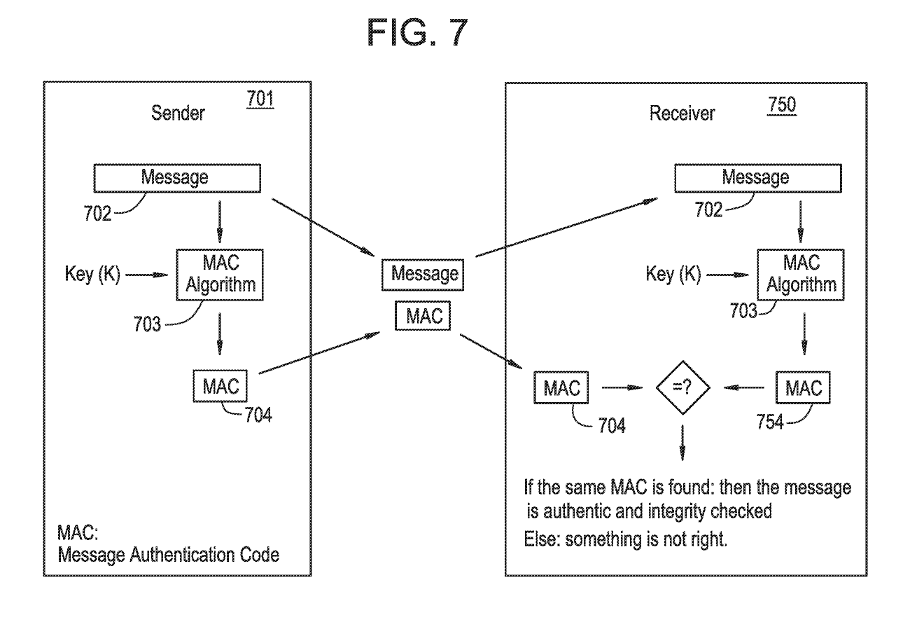

Referring now to FIG. 7, an alternative embodiment can be implemented where a ‘message authentication code (MAC)’ technique is implemented to verify that the authentication code received is in compliance with the received key. In FIG. 7, a sender 701 of an authentication code 702 runs it through a MAC algorithm 703 to produce a MAC data tag 704. The authentication code 702 and the MAC tag 704 are then sent to a receiver 750. The receiver 750 in turn runs the authentication code 702 portion of the transmission through the same MAC algorithm 703 using the same key, producing a second MAC data tag 754. The receiver then compares the first MAC tag 704 received in the transmission to the second generated MAC tag 754. If they are identical, the receiver can safely assume that the authentication code was not altered or tampered with during transmission (data integrity).

Alternatively, in some embodiments of the disclosure additional encrypt/decrypt keys to encrypt message & MAC can be employed to verify if the authentication code received is in compliance with the received key. For example, in some embodiments to allow the receiver to be able to detect replay attacks, the authentication code itself can contain data that assures that this same message can only be sent once (e.g. time stamp, sequence number or use of a one-time MAC). In some exemplary embodiments, encryption and decryption can use well-known methods, such as for example, RSA, Tripple DES, AES, etc.

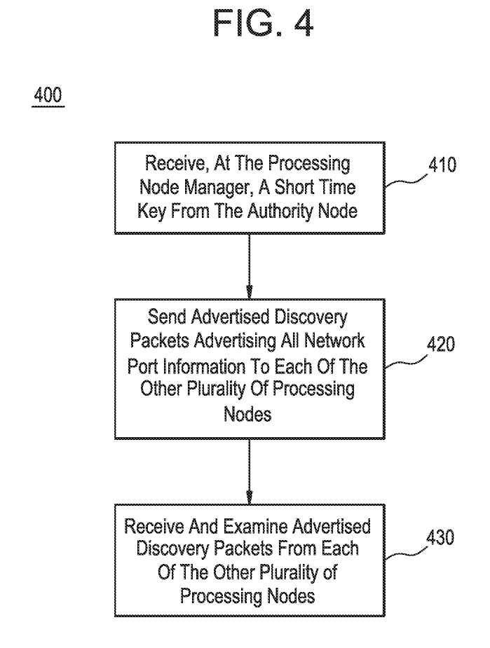

A flow chart for carrying out the method 400 in accordance with the exemplary distributed network system 100 is shown in FIG. 4. As detailed above, the processing nodes 110 can communicate with one or more authority nodes 120. The authority nodes 120 can store policy data for each processing node 110 and can distribute the policy data to each processing node 110. The policy data can, for example, define security policies for a protected system, e.g., security policies for the enterprise 200. As an initial matter, the processing node 110 is configured to receive, at the processing node manager 118, a short time key from the authority node 120, wherein the short time key comprises an instruction to forward advertised discovery packets to each of the plurality of processing nodes at step 410. The detection processing filter 112 can be used to process requests to determine whether the requesting network device is valid or invalid. Where the detection processing filter 112 determines that short time key is authenticated and the requesting network device is valid, the short time key can include an instruction to direct the processing node 110 to forward advertised discovery packets to each of the remaining processing nodes.

At step 420, advertised discovery packets advertising all network port information and the application-specific information stored within the network port information database 114 to the remaining processing nodes 110n are sent to each of the other plurality of processing nodes 110n. In some embodiments, the advertising of the network port information of the selected processing node can be arranged in a discovery packet sent to the other processing nodes 110n. Specifically, in some embodiments the discovery packets can include the short time key received from the authority node manager 128 of the authority node 120 and application-specific information maintained in the processing node 110.

At step 430, the processing node manager 118 of selected processing node 110 can also receive and examine advertised packets from the other processing nodes 110n. In some embodiments, the advertised packets from the remaining processing nodes 110n can include an authentication code. Where the detection processing filter 112 determines the authentication code is in compliance with the short time key from the authority node 120, the processing node 110 can connect to the remaining processing nodes 110n.

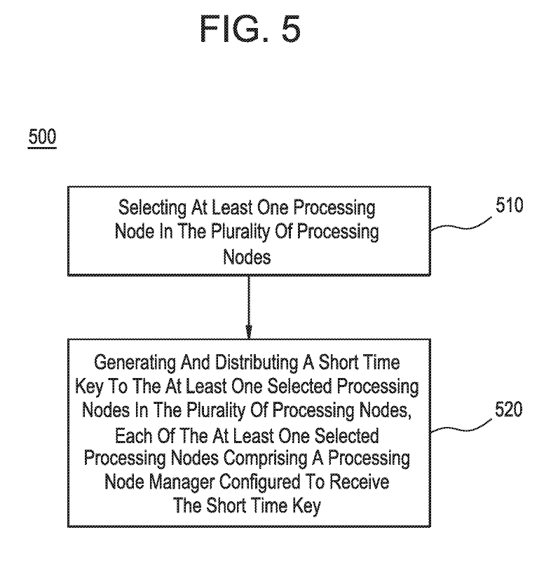

A flow chart for carrying out the method 500 in accordance with the alternative exemplary local area system 200 is shown in FIG. 5. As an initial matter, the authority node manager 128 can select at least one processing node 110 from the plurality of processing nodes 110n at step 510. Alternatively, a processing node 110, operating as a control node, can select at least one processing node 110 from the plurality of processing nodes 110n at step 510.

At step 520, the authority node manager 128 is configured to generate and distribute a security policy to a selected processing node 110. In some embodiments, the security policy can include a short time key that can include an instruction to direct the selected processing node 110 to forward advertised discovery packets to each of the remaining processing nodes 110n.

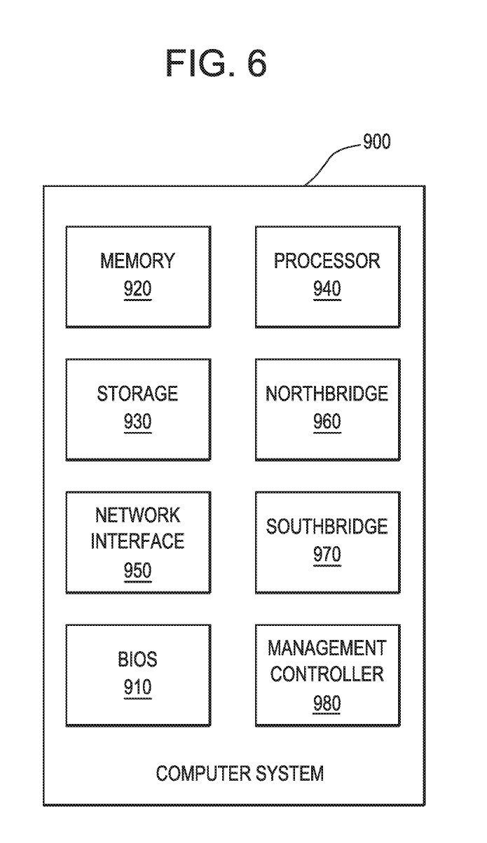

FIG. 6 illustrates a block diagram of an example computer system 900. The computer system 900 can include a processor 940, a network interface 950, a management controller 980, a memory 920, a storage 930, a Basic Input/Output System (BIOS) 910, and a northbridge 960, and a southbridge 970.

The computer system 900 can be, for example, a server (e.g., one of many rack servers in a data center) or a personal computer. The processor (e.g., central processing unit (CPU)) 940 can be a chip on a motherboard that can retrieve and execute programming instructions stored in the memory 920. The processor 940 can be a single CPU with a single processing core, a single CPU with multiple processing cores, or multiple CPUs. One or more buses (not shown) can transmit instructions and application data between various computer components such as the processor 940, memory 920, storage 930, and networking interface 950.

The memory 920 can include any physical device used to temporarily or permanently store data or programs, such as various forms of random-access memory (RAM). The storage 930 can include any physical device for non-volatile data storage such as a HDD or a flash drive. The storage 930 can have a greater capacity than the memory 920 and can be more economical per unit of storage, but can also have slower transfer rates.

The BIOS 910 can include a Basic Input/Output System or its successors or equivalents, such as an Extensible Firmware Interface (EFI) or Unified Extensible Firmware Interface (UEFI). The BIOS 910 can include a BIOS chip located on a motherboard of the computer system 900 storing a BIOS software program. The BIOS 910 can store firmware executed when the computer system is first powered on along with a set of configurations specified for the BIOS 910. The BIOS firmware and BIOS configurations can be stored in a non-volatile memory (e.g., NVRAM) 920 or a ROM such as flash memory. Flash memory is a non-volatile computer storage medium that can be electronically erased and reprogrammed.

The BIOS 910 can be loaded and executed as a sequence program each time the computer system 900 is started. The BIOS 910 can recognize, initialize, and test hardware present in a given computing system based on the set of configurations. The BIOS 910 can perform self-test, such as a Power-on-Self-Test (POST), on the computer system 900. This self-test can test functionality of various hardware components such as hard disk drives, optical reading devices, cooling devices, memory modules, expansion cards and the like. The BIOS can address and allocate an area in the memory 920 in to store an operating system. The BIOS 910 can then give control of the computer system to the OS.

The BIOS 910 of the computer system 900 can include a BIOS configuration that defines how the BIOS 910 controls various hardware components in the computer system 900. The BIOS configuration can determine the order in which the various hardware components in the computer system 900 are started. The BIOS 910 can provide an interface (e.g., BIOS setup utility) that allows a variety of different parameters to be set, which can be different from parameters in a BIOS default configuration. For example, a user (e.g., an administrator) can use the BIOS 910 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 980 can be a specialized microcontroller embedded on the motherboard of the computer system. For example, the management controller 980 can be a BMC or a RMC. The management controller 980 can manage the interface between system management software and platform hardware. Different types of sensors built into the computer system can report to the management controller 980 on parameters such as temperature, cooling fan speeds, power status, operating system status, etc. The management controller 980 can monitor the sensors and have the ability to send alerts to an administrator via the network interface 950 if any of the parameters do not stay within preset limits, indicating a potential failure of the system. The administrator can also remotely communicate with the management controller 980 to take some corrective action such as resetting or power cycling the system to restore functionality.

The northbridge 960 can be a chip on the motherboard that can be directly connected to the processor 940 or can be integrated into the processor 940. In some instances, the northbridge 960 and the southbridge 970 can be combined into a single die. The northbridge 960 and the southbridge 970, manage communications between the processor 940 and other parts of the motherboard. The northbridge 960 can manage tasks that require higher performance than the southbridge 970. The northbridge 960 can manage communications between the processor 940, the memory 920, and video controllers (not shown). In some instances, the northbridge 960 can include a video controller.

The southbridge 970 can be a chip on the motherboard connected to the northbridge 960, but unlike the northbridge 960, is not directly connected to the processor 940. The southbridge 970 can manage input/output functions (e.g., audio functions, BIOS, Universal Serial Bus (USB), Serial Advanced Technology Attachment (SATA), Peripheral Component Interconnect (PCI) bus, PCI eXtended (PCI-X) bus, PCI Express bus, Industry Standard Architecture (ISA) bus, Serial Peripheral Interface (SPI) bus, Enhanced Serial Peripheral Interface (eSPI) bus, System Management Bus (SMBus), etc.) of the computer system 900. The southbridge 970 can be connected to or can include within the southbridge 970 the management controller 970, Direct Memory Access (DMAs) controllers, Programmable Interrupt Controllers (PICs), and a real-time clock.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In one or more exemplary designs, the functions described can be implemented in hardware, software, firmware, or any combination thereof. If implemented in software, the functions can be stored on or transmitted over as one or more instructions or code on a non-transitory computer-readable medium. Non-transitory computer-readable media includes both computer storage media and communication media including any medium that facilitates transfer of a computer program from one place to another. A storage media can be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A network system, comprising:
a plurality of processing nodes, wherein each of the processing nodes comprises a processing node manager configured to perform operations comprising:
receiving a key via a secured connection, wherein the key comprises an instruction to forward advertised discovery packets to each of the plurality of processing nodes;
sending advertised discovery packets advertising network port information to each of the other plurality of processing nodes; and
receiving and examining advertised discovery packets from each of the other plurality of processing nodes, the advertised discovery packets comprising an authentication code, wherein examining the advertised discovery packets comprises verifying the authentication code is compliant with the received key.

2. The network system of claim 1, wherein the advertised discovery packets comprises the key and application-specific information maintained in the processing node.

3. The network system of claim 1, wherein the key is received from an authority node.

4. The network system of claim 1, wherein the key is received from a control node from the plurality of the processing nodes.

5. The network system of claim 4, wherein the control node is configured to:
select at least one processing node in the plurality of processing nodes; and
generate and distribute a key to the at least one selected processing nodes in the plurality of processing nodes, wherein the key comprises an instruction to the at least one selected processing nodes to forward advertised discovery packets to each of the plurality of processing nodes.

6. The network system of claim 4, wherein the control node is selected from the plurality of processing nodes by an authority node.

7. The network system of claim 1, wherein the key comprises a variable length passcode.

8. The network system of claim 1, wherein the key comprises a short time key.

9. A computer-implemented method for providing data security to network elements, comprising:
receiving a key via a secured connection, wherein the key comprises an instruction to forward advertised discovery packets to each of the plurality of processing nodes;
sending advertised discovery packets advertising network port information to each of the other plurality of processing nodes; and
receiving and examining advertised discovery packets from each of the other plurality of processing nodes, the advertised discovery packets comprising an authentication code, wherein examining the advertised discovery packets comprises verifying the authentication code is compliant with the received key.

10. The computer-implemented method of claim 9, wherein the advertised discovery packets comprises the key and application-specific information maintained in the processing node.

11. The computer-implemented method of claim 9, wherein the key is received from an authority node.

12. The computer-implemented method of claim 9, wherein the key is received from a control node from the plurality of the processing nodes.

13. The computer-implemented method of claim 12, wherein the control node is configured to:
select at least one processing node in the plurality of processing nodes; and
generate and distribute a key to the at least one selected processing nodes in the plurality of processing nodes, wherein the key comprises an instruction to the at least one selected processing nodes to forward advertised discovery packets to each of the plurality of processing nodes.

14. The computer-implemented method of claim 13, wherein the control node is selected from the plurality of processing nodes by an authority node.

15. The computer-implemented method of claim 9, wherein the key comprises a variable length passcode.

16. The computer-implemented method of claim 9, wherein the key comprises a short time key.

17. A computing device, comprising:
a memory containing machine readable medium comprising machine executable code having stored thereon instructions for performing a method for providing data security to network elements;
a processor coupled to the memory, the processor configured to execute the machine executable code to cause the processor to:
receive a key via a secured connection, wherein the key comprises an instruction to forward advertised discovery packets to each of the plurality of processing nodes;
send advertised discovery packets advertising network port information to each of the other plurality of processing nodes; and
receive and examine advertised discovery packets from each of the other plurality of processing nodes, the advertised discovery packets comprising an authentication code, wherein examining the advertised discovery packets comprises verifying the authentication code is compliant with the received key.

18. The computing device of claim 17, wherein the advertised discovery packets comprises the key and application-specific information maintained in the processing node.

19. The computing device of claim 17, wherein the key is received from an authority node.

20. The computing device of claim 17, wherein the key is received from a control node from the plurality of the processing nodes.

21. The computing device of claim 20, wherein the control node is configured to:
select at least one processing node in the plurality of processing nodes; and
generate and distribute a key to the at least one selected processing nodes in the plurality of processing nodes, wherein the key comprises an instruction to the at least one selected processing nodes to forward advertised discovery packets to each of the plurality of processing nodes.

22. The computing device of claim 20, wherein the control node is selected from the plurality of processing nodes by an authority node.

23. The computing device of claim 17, wherein the key comprises a variable length passcode.

24. The computing device of claim 17, wherein the key comprises a short time key.
